(19) United States
(12) Patent Application Publication
(10) Pub. No.: US 2012/0084144 A1
(43) Pub. Date: Apr. 5, 2012

(54) ADVERTISEMENT SERVICE SYSTEM AND METHOD THEREOF

(75) Inventor: Sang Il SHIM, Gyeonggi-do (KR)

(73) Assignee: NHN BUSINESS PLATFORM CORPORATION, Seongnam-si (KR)

(21) Appl. No.: 13/243,842

(22) Filed: Sep. 23, 2011

(30) Foreign Application Priority Data
Sep. 30, 2010 (KR) 10-2010-0095587

(51) Int. Cl. G06Q 30/00

(52) U.S. Cl. 705/14.46; 705/14.4; 705/14.71

(57) ABSTRACT

An advertisement service system includes an advertisement application service providing module to provide an advertisement application service to a publisher, in which the advertisement application service provides the publisher online access to manage operation of an advertisement resource belonging to the publisher; an opened transaction service providing module to provide an opened transaction service that enables advertisement resource of the publisher to be transacted between the publisher and an advertiser or an advertisement agency; and an advertisement reporting module to provide a report about the advertisement resource executed by the advertisement application service providing module.

### CROSS-REFERENCE TO RELATED APPLICATIONS

This application claims priority from and the benefit of Japanese Patent Application No. 10-2000-0095587, filed on Sep. 30, 2010, which is incorporated herein by reference for all purposes as if fully set forth herein.

### BACKGROUND

1. Field

This disclosure relates to an advertisement service system and a method thereof, and more particularly, to an advertisement service system and a method for enabling publishers to perform advertisement execution and/or management operation.

2. Discussion of the Background

With the widespread use of the Internet, users may acquire various pieces of is information through the Internet. That is, a user can get various contents via an Internet search site or portal site using a terminal device, such as a personal computer, or the like, which can access the Internet by directly inputting an address of a website including such content or information.

As the number of users who find desired contents through the Internet increases, a company (hereinafter, referred to as a “publisher or contents owner”) possessing the contents on a web-page accessed by the user, may provide one or more advertisements to the users through the provided web-page or website to acquire revenues. More specifically, the publisher of a web-page may generate revenues by selling designated on-line advertisement areas on the web-page. Accordingly, more popular web-pages may be able to charge more for advertisement space to generate revenues. However, a plurality of users may access target contents through an Internet search site or portal site (hereinafter, referred to as a “contents agent”) rather than accessing the contents directly through the publisher's webpage. The contents agent may be more popular and familiar than the traditional websites among various users, and more frequently accessed than the web-page directly provided by the publisher or contents owner. Therefore, web-pages of the publishers or contents owners possessing the contents may incur a deteriorated advertisement revenues and may not be particularly attractive to an advertiser who may seek to purchase advertisement space, whereas, the advertisement demand for the contents agent may be higher than the traditional websites.

More specifically, several contents agents who are highly popular with respect to a wide user base may provide a service to expose the contents of the publisher or contents user through a search or regardless of the search, such that the users can access the contents owned by the publisher or content owner through the contents agents. Accordingly, there may be many is publishers or contents owners that may be less successful in associating their own advertisement resources (advertisement areas or space of the web-page, which can be used to provide or display online advertisements) with direct advertisement sales due to low media power or business power of the publisher or contents owner. Moreover, media power and business power of the contents agent, which can acquire high advertisement revenues through high awareness, cannot be actually properly used.

Further, since some of the publishers or contents owners forcibly publish advertisements, which may be less related with the contents or its owner in order to acquire the advertisement revenues (for example, an adolescent advertisement is published in current affairs, economic, and news contents), some of advertisements displayed on the publishers or contents owners are further ignored by the user. As a result, the advertisement revenues may be further reduced and reliability of the contents agent that exposes the corresponding contents may also be reduced.

Meanwhile, the Internet search site or portal site (contents agent), which may be highly popular and familiar, may generally operate an advertisement system upgraded with high-priced Internet equipment, many customers, and accumulated advertisement operating and managing knowledge. Contrary to this, the publishers or contents owners may have limited resources in terms of number of Internet equipment, customers, and advertisement operating knowledge. Further, the publishers or contents owners may expect to generate revenues through the advertisement owned by the publishers themselves in addition to the contents. However, since the users do not frequently access the advertisement resources that are owned and managed by the publishers or contents owners themselves, it may be difficult for the publishers or contents owner to convert the advertisement resources into the advertisement revenues.

Meanwhile, the advertisers, the advertisement agencies, and the advertisement agents may intend to wide their own business areas by using the advertisements in their own ways. Accordingly, an advertisement service system capable of satisfying the purposes of the businesses of the advertisers, the advertisement agencies, the advertisement makers, and/or the publishers may be sought.

### SUMMARY

Exemplary embodiments of the present invention provide an advertisement service system and a method thereof that enable publishers to perform advertisement execution and/or management operation of their own advertisement resources online.

Additional features of the invention will be set forth in the description which follows, and in part will be apparent from the description, or may be learned by practice of the invention.

Exemplary embodiments of the present invention provide an advertisement service system including an advertisement application service providing module to provide an advertisement application service to a publisher, in which the advertisement application service provides the publisher online access to manage operation of an advertisement resource belonging to the publisher; an opened transaction service providing module to provide an opened transaction service that enables advertisement resource of the publisher to be transacted between the publisher and an advertiser or an advertisement agency; and an advertisement reporting module to provide a report about the advertisement resource executed by the advertisement application service providing module.

Exemplary embodiments of the present invention provide an advertisement is service method including providing an advertisement application service by online access of a registered publisher for management operation of its own advertisement resource by an advertisement application service providing module; providing an opened transaction service for enabling the advertisement resource of the publisher to be transacted between the publisher and an advertiser or an advertisement agency; and providing a report about the advertisement resources executed by the advertisement application service providing module to the publisher and the advertiser or the advertisement agency.

Exemplary embodiments of the present invention provide a computer-readable recording medium storing a computer program executed through at least one computer component and including a program command to perform an advertisement service of an advertisement service system using a communication network, in which: the computer-readable recording medium enables, by the execution, an advertisement service method including, providing an advertisement application service for online access of registered publisher for allowing management operation of its own advertisement resource by an advertisement application service providing module; providing an opened transaction service for enablinges at least some of the advertisement resources of the publisher to be transacted between the publisher and an advertiser or an advertisement agency; and providing a report about the advertisement resources executed by the advertisement application service providing module to the publishers and the advertiser or the advertisement agency.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a relationship diagram illustrating an advertisement service system according to an exemplary embodiment of the invention.

FIG. 2 is a block diagram illustrating an advertisement service system configuration according to an exemplary embodiment of the invention.

FIG. 3 is a flow diagram illustrating an operation of an advertisement application service providing module according to an exemplary embodiment of the invention.

FIG. 4 is a flow diagram illustrating an operation of an opened transaction service providing module according to an exemplary embodiment of the invention.

FIG. 5 is a flow diagram illustrating an operation of an opened transaction service providing module according to an exemplary embodiment of the invention.

FIG. 6 is a flow diagram illustrating an operation of an opened transaction service providing module according to an exemplary embodiment of the invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. Throughout the drawings and the detailed description, unless otherwise described, the same drawing reference numerals are understood to refer to the same elements, features, and structures. The relative size and depiction of these elements may be exaggerated for clarity, illustration, and convenience.

General principles mentioned below may be applied to other exemplary embodiments and applications. For example, even though a series of operations will be described with reference to a flow chart, a sequence of the operations may be changed in other exemplary embodiments. In addition, independent operations may be performed in parallel with each other. Unless any components, operations, or commands used in the description are explicitly specified, they should not be construed as being important or basic in the present invention. As used herein, a singular form should be considered as including at least one item. In the case of expressing only one item, “one” or similar terms will be used.

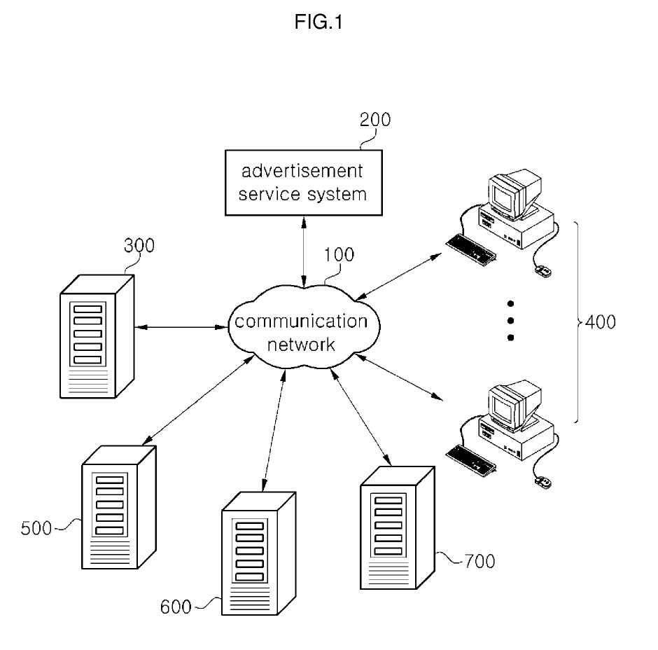

FIG. 1 is a diagram showing an advertisement service ecosystem according to an exemplary embodiment of the present invention.

As shown in FIG. 1, an advertisement service ecosystem includes a communication network 100, an advertisement service system 200, an advertiser terminal 300, a plurality of user terminals 400, an advertisement agency terminal 500, an advertisement maker terminal 600, and a publisher terminal 700. In an example, the plurality of user terminals 400 may input a reference query by accessing the advertisement service system 200 through the communication network 100 to receive an advertisement corresponding to the query (e.g., a banner advertisement, a pop-up advertisement, and the like). However, the present invention is not limited to the banner advertisement and may be appropriately modified to be applied to is various advertisements online.

The communication network 100 may be a network that supports communication between the system and terminals shown in FIG. 1. A configuration of base communication technologies constituting the communication network 100 may not have a fundamental influence on implementing the present invention.

The communication network 100 may be configured regardless of communication modes, such as wired and wireless modes. The communication network 100 may be configured based on various types of communication technology that can exchange information between the system and the terminals. Further, various technologies supporting reliability and security during exchanging the information may be applied to the communication network 100.

The advertiser terminal 300 may include a digital apparatus, which may allow the advertiser to communicate with the advertisement service system 200 after accessing the advertisement service system 200. The digital apparatus may be, without limitation, an industrial server, a personal computer and the like. Examples of the personal computer may include, without limitation, a desktop computer, a notebook computer, a workstation, a personal digital assistant (PDA), a web pad, a cellular phone, and the like. Further, a digital apparatus including a memory section and a microprocessor, with calculation capability may be used as the digital apparatus constituting the advertiser terminal 300.

More specifically, the advertiser terminal 300 may include an application program or a program module to allow the advertiser to input information related to an advertisement or advertisement providing information in the advertisement service system 200, to select a plurality of advertisement images/messages used to provide the advertisement, and/or to verify an advertisement report index is displayed. In an example, the advertisement report index may include, without limitation, click information, traffic information, website navigation information, duration information, and the like. The application program or program module may be transmitted from the advertisement service system 200.

Further, the advertiser terminal 300 may include a homepage operating server, which the advertiser operates to provide various contents or services.

The advertiser terminal 300 communicates with the advertisement service system 200 to receive and display an advertisement report provided from the advertisement service system 200.

The user terminal 400 is a digital apparatus, which may communicate with the advertisement service system 200 by accessing the advertisement service system 200 through the communication network 100. The user terminal 400 may include, without limitation, a desktop computer, a notebook computer, a workstation, a personal digital assistant (PDA), a web pad, a cellular phone, or the like. Further, a digital apparatus including a memory section and a microprocessor, with calculation capability may be used as the digital apparatus constituting the advertiser terminal 400. The user terminal 400 may further include a web browser (not shown) program to receive the contents.

The advertisement agency terminal 500 may access the advertisement service system 200 to support communication between advertisement agency and the advertisement service system 200. The advertisement agency terminal 500 may include, without limitation, an industrial server, a personal computer, and the like. Examples of the personal computer may include a desktop computer, a notebook computer, a workstation, a PDA, a web pad, a cellular phone, and the like. In addition, the advertisement agency terminal 500 may also include a digital apparatus with a calculation capability, a memory, and a microprocessor.

The advertisement agency terminal 500 may be substituted by a homepage operating server, which the advertisement agency may operate to perform the advertisement agent business.

The advertisement maker terminal 600 may include a digital apparatus, which may allow the advertisement maker to communicate with the advertisement service system 200 to conduct an advertisement making business after accessing the advertisement service system 200. The digital apparatus may be, without limitation, an industrial server, a personal computer and the like. Examples of the personal computer may include, without limitation, a desktop computer, a notebook computer, a workstation, a PDA, the web pad, a cellular phone, and the like. Further, a digital apparatus including the memory section and the microprocessor, with calculation capability may be used as the digital apparatus constituting the advertisement maker terminal 600.

Further, the advertisement maker terminal 600 may include a homepage operating server, which the advertisement maker operates to perform operations related to the advertisement making business.

The publisher terminal 700 may include a digital apparatus, which may allow the publisher to communicate with the advertisement service system 200 after accessing the advertisement service system 200. The digital apparatus may be, without limitation, an industrial server, a personal computer and the like. Examples of the personal computer may include, without limitation, a desktop computer, a notebook computer, a workstation, a PDA, a web pad, a cellular phone, and the like. Further, a digital apparatus including the memory section and the microprocessor, with calculation capability may be used as the digital apparatus constituting the publisher terminal 700.

The publisher terminal 700 may allow the publisher to perform advertisement execution and/or management operation of its own advertisement resources by using the advertisement application service provided from the advertisement service system 200 after accessing the advertisement service system 200. In an example, the advertisement application service may be provided by an advertisement application service providing module, which may be included in the advertisement service system 200.

Further, the publisher terminal 700 may allow the publisher to use the opened transaction service provided from the advertisement service system 200 by accessing the advertisement service system 200 to transact at least some of the advertisement resources of the publisher between the advertisers or the advertisement agencies.

In addition, the publisher terminal 700 may receive a report about the performance of the advertisement using an advertisement resource, which may be executed in the advertisement service system 200. The report may be further relayed to the publisher.

The publisher terminal 700 may be substituted by a site operating server, which the publisher may operate in order to provide online contents, services, and other advertisement resources.

If the user terminal 400 inputs a query on a web site operated by the publisher terminal 700, the publisher terminal 700 may provide, for example, a banner advertisement (or any similar advertisement form or type) associated with the corresponding query to a search result page. The banner advertisement may be provided to a partial area of the search result page by the advertisement service system 200.

A system that provides the search result page as a response to the query of the user terminal 400 may be a search engine system configured separately from the advertisement is service system 200.

The advertisement service system 200 may receive a request to provide the banner advertisement or other advertisement type associated with the query inputted from the user terminal 400, which may be displayed on a reference area of the search result page by using the search engine system.

The advertisement service system 200 may communicate with the advertiser terminal 300, the user terminal 400, the advertisement agency terminal 500, the advertisement maker terminal 600, and the publisher terminal 700 through the communication network 100. Moreover, the advertisement service system 200 may register and publish the advertisement resources (online advertisement area) managed by the publisher or the advertisement service system 200 itself according to the requests from the advertiser terminal 300 and/or the advertisement agency terminal 500. Further, if the advertisement is provided to the user terminal 400 according to user selection (e.g., by user clicking on the advertisement), the advertisement service system 200 may charge the advertiser, the advertisement agency, and the publisher. The advertisement service system 200 may be included in the operating server of the Internet portal site that performs search advertising, display advertising, and the like.

The advertisement service system 200 may permit the publishers accessed through the publisher terminal 700 to use the advertisement application service to allow the corresponding publishers to perform advertisement execution and/or management operation of their own advertisement resources.

The advertisement service system 200 may allow the publisher to apply advertisements on free advertisement resources and/or paid advertisement resources by using the advertisement application service.

The advertisement service system 200 may permit the publishers to use the advertisement application service for free if an advertisement execution rate of the paid advertisement resources is equal to or more than a reference rate when the publishers use the advertisement application service.

The advertisement service system 200 may estimate a reference rate of revenues by calculating advertisement execution of the paid advertisement resources as a charge for the advertisement application module with respect to the publisher using the advertisement application service. In an example, an advertisement may be executed if a user clicks on the respective advertisement corresponding to the advertisement resource. If the advertisement resource is a paid advertisement resource, a charge may be incurred.

Further, the advertisement service system 200 may enable at least some of the advertisement resources of the publishers, which may be executed and/or managed by using the advertisement application service, to be transacted between the publishers and the advertiser or the advertisement agency. Furthermore, the advertisement service system 200 may transact the advertisement resources, which may be executed and/or managed by the advertisement service system 200 itself rather than the advertisement resources of the publishers, with respect to the advertiser or the advertisement agency.

The advertisement service system 200 may transact the advertisement resources consigned from the publishers, in which the publishers may execute and/or manage advertisement resources, with respect to the advertiser or the advertisement agency.

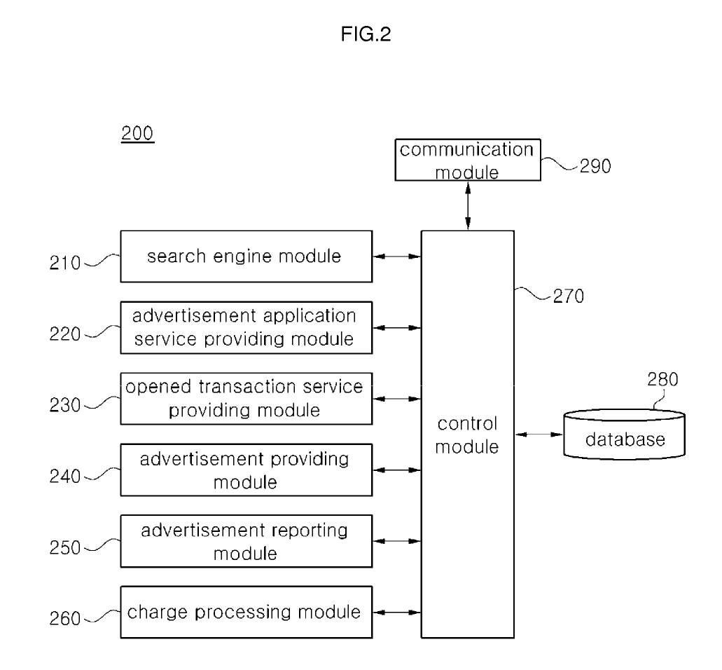

FIG. 2 is a block diagram illustrating an advertisement service system configuration according to an exemplary embodiment of the invention.

Referring to FIG. 2, the advertisement service system 200 may include a search is engine module 210, an advertisement application service providing module 220, an opened transaction service providing module 230, an advertisement providing module 240, an advertisement reporting module 250, a charge processing module 260, a control module 270, a database 280, and a communication module 290.

Herein, the components constituting the advertisement service system 200 are illustrated as being implemented in one apparatus, but the present invention is not limited thereto and the components may be implemented in separate systems or components and communicate with each other to perform desired data processing.

The search engine module 210, the advertisement application service providing module 220, the opened transaction service providing module 230, the advertisement providing module 240, the advertisement reporting module 250, the charge processing module 260, the control module 270, the database 280, and the communication module 290 may refer to programs modules and/or physical devices executing the program modules. These modules may communicate with the advertiser terminal 300, the user terminal 400, the advertisement agency terminal 500, the advertisement maker terminal 600, and/or the publisher terminal 700. The modules may be an operating system, an application program module, and/or other program modules, which may be included in the advertisement service system 200 and may be physically stored in various known storage devices. Further, the modules may be stored in a remote storage device, which can communicate with the advertisement service system 200. Meanwhile, the modules may include a routine, a subroutine, a program, an object, a component, a data structure, and the like to perform a reference business operation or execute a reference abstractive data type.

The search engine module 210 may serve to crawl or search a web document. In is an example, the web document may collectively refer to various data, such as a text, an image, a moving picture, audio, a combination of various data types and the like. The web documents may be displayed and/or stored in a remote computer connected through a communication network. The crawled web document may be stored in the database 280, and be provided to the user according to the request from the user terminal 400.

The advertisement application service providing module 220 may permit registered publishers to access and use the advertisement application service to allow the corresponding publishers to sell and manage their own advertisement resources. Publishers may sell and manage their advertisement resources through advertisement application service provided through the application service providing module 220.

The advertisement application service providing module 220 may be an application service provider (ASP) to provide advertisement management. In general, the ASP may be applied to a business field and a service that constructs an information technology (IT) environment by leasing various programs and systems, such as hardware, software, and the like.

Accordingly, the advertisement application service providing module 220 may provide a service in which the publishers perform an advertisement by applying an advertisement management service to an advertisement service system. The advertisement service system may operate the advertisement application service providing module 220 without purchasing all equipment and software required for advertisement management and may be advantageous in that it is relative inexpensive and analysis can be easily started.

The advertisement application service providing module 220 may provide the advertisement application service to the publishers to permit online access of the registered publishers to allow the corresponding publishers to perform advertisement execution and/or is management operation of their own advertisement resources.

The advertisement application service providing module 220 may be configured to apply an advertisement on the free advertisement resources and/or the paid advertisement resources.

The advertisement application service providing module 220 may be configured to permit the publishers to use the advertisement application service for free if an advertisement execution rate of the paid advertisement resources is equal to or more than a reference rate.

The advertisement application service providing module 220 may be configured to estimate a reference rate of revenues by advertisement execution of the paid advertisement resources as a charge for the advertisement application module.

The opened transaction service providing module 230 provides an opened transaction service that enables at least some of the advertisement resources of the publishers, which may be executed and/or managed by the advertisement application service providing module 220, to be transacted between the publishers and the advertiser or the advertisement agency. At this time, the opened transaction service providing module 230 may provide an opened transaction service that enables at least some of the advertisement resources of the publishers to be transacted between the publishers and the advertiser or the advertisement agency based on an auction concept. In an example, if the advertiser or the advertisement agency is willing to bid on the advertisement resource of the publisher, equal or higher than an amount designated by the publisher, the advertisement resource may be provided to the advertiser or the advertisement agency to be executed and/or managed. If the advertiser or the advertisement agency bid on the advertisement resource of the publisher with a lower figure than the amount designated by the publisher, the publisher may use the advertisement resource for its own is purposes.

The opened transaction service providing module 230 may transact the advertisement resources, which may be executed and/or managed by the opened transaction service providing module 230 itself rather than the advertisement resources of the publishers with respect to the advertiser or the advertisement agency. At this time, the opened transaction service providing module 230 may provide an opened transaction service that enables the corresponding advertisement resources to be transacted between the publishers and the advertiser or the advertisement agency based on an auction concept.

The opened transaction service providing module 230 may transact the advertisement resources consigned from the publishers with respect to execution and/or management thereof with respect to the advertiser or the advertisement agency. The opened transaction service providing module 230 may provide the opened transaction service that enables the corresponding advertisement resources to be transacted between the publishers and the advertiser or the advertisement agency based on the auction concept.

The advertisement providing module 240 may serve to provide the advertisement to the user terminal 400. That is, if the user of the user terminal 400 inputs a query through an operating site operated by the advertisement service system 200, an advertisement image, a message, and/or the advertisement image and message corresponding to the query included in the search result page in the form of the banner advertisement may be provided to the user. The advertisement providing module 240 may refer to a database that stores advertisement providing information of the advertiser, which matches the inputted query. Such databases may include database 280.

The advertisement providing module 240 may receive the advertisement is providing information from the advertiser terminal 300 prior to providing the advertisement to the user terminal 400. The advertisement providing information may include, without limitation, an advertisement material associated with the corresponding advertisement, title and description information (T&D) of the advertisement to be provided to the user. The advertisement providing information may be stored in the database 280. The advertisement material may include, without limitation, an advertisement image, a message, a flash, and a combination thereof belonging to the advertiser.

The advertisement providing module 240 may provide an advertisement having the form of the banner advertisement with the response to the search result. Further, as described above, if an additional publishing system is concerned in providing the advertisement, the advertisement providing module 240 may configure some of the contents provided to the user terminal 400 and may serve to control an advertisement listing provided as a part of the search result.

More specifically, the advertisement providing module 240 may provide online advertisement to the user terminal 400 according to the advertisement providing information inputted through the advertiser terminal 300. The online advertisement may be, for example, the banner advertisement (or other types of advertisements) including a plurality of advertisement materials. The plurality of advertisement materials may be exposed according to a reference exposure rate configured to the banner advertisement (or other types of advertisements). The exposure rate may be, without limitation, a positional exposure rate, a temporal exposure rate, a combination of positional and temporal exposure rates, and the like.

The online advertisement may have various inherent features. The features may be specified by the application and/or the advertiser. The features are hereinafter referred to as is advertisement features. For example, the advertisement features may include, without limitation, images, execution code, embedded links, and the like. According to the type of the online advertisement, the advertisement features may include one or more features, such as a text, a link, an audio file, a video file, an image file, the execution code, embedded information, and the like.

The advertisement providing module 240 may include an advertisement registration operation. The advertisement providing module 240 may serve to store advertisement data as an advertisement consisting of the data such as text, image, moving picture, audio, combination thereof, and the like. The advertisement data may be selected or designated by the advertiser. The advertisement data may be stored in the database 280 according to the request from the advertiser terminal 300. Further, the advertisement providing module 240 may provide a reference interface, such as a known online advertisement bidding tool, to the advertiser terminal 300 in order to register the advertisement. In a general keyword searching advertisement, operations to support bidding by the advertiser may be provided by the advertisement providing module 240. The advertisement providing module 240 may store information regarding the advertisement registration of the advertiser by communicating with the database 280 within a target range.

Further, the advertisement providing module 240 may analyze click information regarding one or more of the advertisement materials constituting the banner advertisement to accumulate analyzed data in the database 280. In an example, click information may include frequency, time, and other information related to the clicking of the advertisement materials by the user. Since the data accumulated in the database 280 may reflect user preference on one or more advertisement materials, the advertisement providing module 240 may evaluate is advertisement performance or an advertisement effect for one or more advertisement materials based on an analysis result. The advertisement performance or the advertisement effect may include the click information related to one or more advertisement materials accumulated in the database 280. Evaluation information of the advertisement material estimated by the advertisement providing module 240 may be used while controlling the advertisement material in order to improve the advertisement effect. Further, the advertisement material evaluation information estimated by the advertisement providing module 240 may be used in the advertisement reporting module 250. The advertisement reporting module 250 may perform a service to report the advertisement performance or advertisement effect of one or more advertisement material constituting the corresponding banner advertisement to the advertiser and/or propose the improvement of the advertisement based on the report.

The advertisement reporting module 250 may provide a report about the advertisement resources executed by the advertisement application service providing module 220 to the publishers and the advertiser or the advertisement agency.

For example, the advertisement reporting module 250 may provide the advertisement report about the advertisement resources executed by the advertisement application service providing module 220 or the opened transaction service providing module 230 to the publisher.

Further, the advertisement reporting module 250 may provide to the publisher a transaction report about the advertisement resources of the publisher transacted by the opened transaction service providing module 230 according to the request from the advertisement application service providing module 220.

Moreover, the advertisement reporting module 250 may provide a transaction is report to the publisher. In the transaction report, the advertisement resources consigned to the opened transaction service providing module 230, which may be executed and/or managed in the opened transaction service providing module 230, are provided.

The advertisement reporting module 250 may generate and provide the advertisement resource report to the publisher. The advertisement resource report may include the advertisement performance or advertisement effect, which may be based on a position to which the corresponding advertisement resource belongs, positional control of the advertisement resource, a banner advertisement executed by a newly controlled advertisement resource, an improvement effect of the advertisement performance before and after the position of the advertisement resource is controlled.

Accordingly, the publisher may receive the advertisement resource report through the publisher terminal 700 to determine user response for one or more positions of the advertisement, which may already be placed when the advertisement resource is placed afterwards on the basis of the advertisement resource report.

Similarly, the advertiser, the agency, and/or the advertisement makers may receive the corresponding report from the advertisement reporting module 250 through the advertiser terminal 300, the advertisement agency terminal 500, and/or the advertisement maker terminal 600, respectively to use the received corresponding report as a feedback material.

The advertisement reporting module 250 may generate an advertisement report including the advertisement performance or advertisement effect of the plurality of advertisement materials included in the corresponding advertisement, the control of the advertisement material, the advertisement constituted by the newly controlled advertisement material, and improvement effects of the advertisement performance before and after the is advertisement material is controlled to provide the generated advertisement report to the advertiser terminal 300.

Accordingly, the advertiser may receive the advertisement report through the advertiser terminal 300 to determine user response for one or more advertisement material which may be executed. Similarly, the agency, the advertisement maker, and the publishers may receive the advertisement report through the advertisement agency terminal 500, the advertisement maker terminal 600, and/or the publisher terminal 700, respectively to determine user response for one or more advertisement materials, which may be executed.

The advertisement reporting module 250 may provide the advertisement report if the advertiser makes a request for a report regarding the advertisement execution result or automatically provided according to a reference temporal cycle (e.g., weekly, monthly, hourly, and the like).

The advertisement reporting module 250 may further generate and provide a comment for an advertisement to be executed afterwards to the advertiser. Comments for the advertisement to be executed may include a proposal for the combination of the advertisement materials to achieve a better advertisement effect according to user response for one or more advertisement material.

Accordingly, since the advertiser can determine whether the number of times of users' clicks are generated in large quantities if reference advertisement materials are exposed constituting the corresponding banner advertisement by referring to the advertisement report, the advertiser may execute the advertisement more efficiently by actively reflecting advertisement materials that are known to attract user's interests.

Moreover, the advertisement reporting module 250 may request settlement is processing to the advertiser terminal 300 or process known charges by using a calculated total balance after or before executing the advertisement.

The charge processing module 260 may estimate a charge for the advertisement application service providing module 220 according to a traffic volume generated when the publishers performs execution and/or management operation of their own advertisement resources.

The charge processing module 260 may apply different reference charges according to execution of the free advertisement resources or the paid advertisement resources performed by the advertisement application service providing module 220. Further, the charge processing module 260 may apply different charges according to the differently priced paid advertisement resources.

For example, the charge processing module 260 may permit the publishers to use the advertisement application service providing module for free if an execution rate of the paid advertisement resources is equal to or more than a reference rate (for example, 50% or more of a total execution rate).

Further, the charge processing module 260 may estimate a reference rate (for example, 30% of the revenues) of revenues attributed to the execution of the paid advertisement resources as the charge for the advertisement application module with respect to the publisher.

Therefore, the publisher may create revenues for using the advertisement resource through the advertisement application service provided from the advertisement service system 200 even though the publisher is not equipped with expensive equipment for additional advertisement management with respect to the advertisement resources, which the publisher possesses. Moreover, the advertisement service system 200 may permit the publisher to use the is advertisement application service providing module 220 to create revenues by using the advertisement resources possessed by the publisher.

If the advertisement information provided to the user terminal 400 is specified by the user, the charge processing module 260 may charge a reference charge to the advertiser who registers the corresponding advertisement information. For example, the charge processing module 260 may be applied to a cost per click (CPC) mode in which charges may be applied if the advertisement is clicked, or a cost per sale (CPS) mode in which charges may be applied so that an advertisement charge based on sales may be generated. However, the present invention is not limited thereto and the charge processing module 260 may apply charges by various charging methods. A bidding price in which the advertiser inputs information on the effective number of times of clicks inputted by the advertiser, a quality index of the advertisement, past advertisement execution information, and the like may be used in order to determine a total charge amount. The charge processing module 260 calculates the total charge amount and updates the calculated total charge amount to account information of the advertiser.

The control module 270 may serve to control the flow of data among the search engine module 210, the advertisement application service providing module 220, the opened transaction service providing module 230, the advertisement providing module 240, the advertisement reporting module 250, the charge processing module 260, the database 280, and the communication module 290.

That is, the control module 270 may control the flow of data from the outside or among the components of the advertisement service system 200 to control the search engine module 210, the advertisement application service providing module 220, the opened transaction service providing module 230, the advertisement providing module 240, the advertisement is reporting module 250, the charge processing module 260, the database 280, and the communication module 290 to perform their own operations.

The communication module 290 may serve to transmit the report regarding the advertisement resource executed by the advertisement service system 200 to the publisher terminal 700, the advertiser terminal 300, the advertisement maker terminal 600, and the advertisement agency terminal 500 in order to provide the report to the publishers, the advertiser, the advertisement maker, or the advertisement agency.

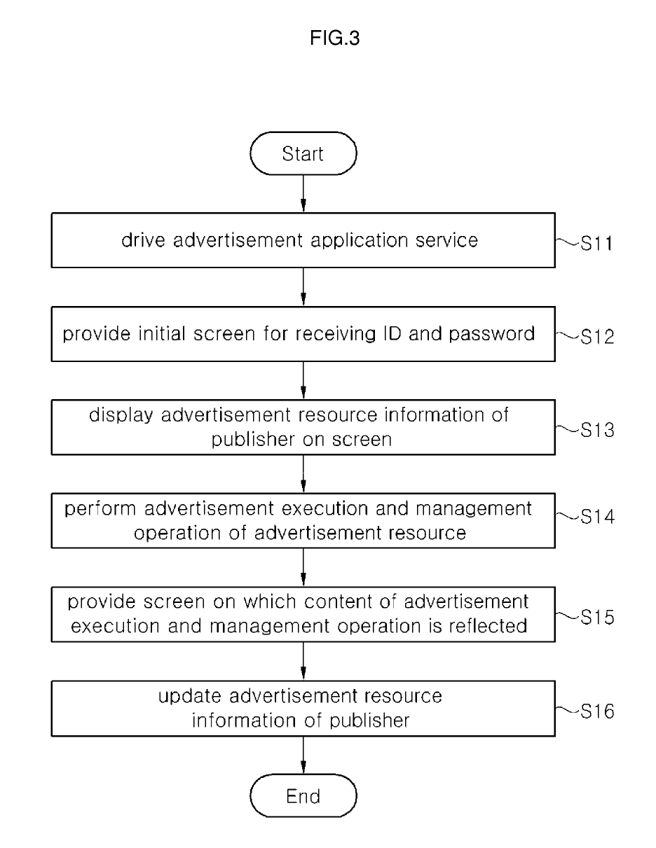

FIG. 3 is a flow diagram illustrating an operation of an advertisement application service providing module according to an exemplary embodiment of the invention.

Referring to FIG. 3, if a publisher accesses an advertisement service system 200 through a publisher terminal 700, an advertisement application service providing module 220 drives an advertisement application service (S11). The advertisement application providing service module 220 provides an initial screen for receiving a user identification (ID) and a password for execution and/or management of an advertisement (S12). The advertisement application service providing module 220 authenticates the inputted user ID and password, retrieves advertisement resource information associated with a corresponding publisher from a database 280, and provides the retrieved advertisement resource information onto a screen for execution and/or management of the advertisement of the corresponding publisher (S13).

The advertisement application service providing module 220 performs an operation for execution and/or management of the advertisement for the advertisement resource of the publisher according to an input of the publisher (S14). For example, the advertisement application service providing module 220 may receive selection information related to advertisement execution of free or paid advertisement resources from the publisher. The is advertisement application service providing module 220 may receive a request for a list of the advertisement resources, which may be executed and/or managed by the corresponding publisher, and advertisement execution situations from the publisher. The advertisement application service providing module 220 may receive a request for the advertisement execution and/or management to be consigned to the advertisement service system 200, among the advertisement resources which can be provided by the publisher.

In operation S15, the advertisement application service providing module 220 provides a new screen to which an operation content is reflected to the publisher (S15). For example, the advertisement application service providing module 220 may determine whether to execute the advertisement of the free advertisement resource or the paid advertisement resource according to the input of the publisher and provide the corresponding result to the screen. The advertisement application service providing module 220 may search the list of the advertisement resources, which may be executed and/or managed by the corresponding publisher, and advertisement execution situations from the publisher. The advertisement application service providing module 220 may provide the searched list and situations to the screen. The advertisement application service providing module 220 may make a request for management of the corresponding advertisement resource to be consigned to an opened transaction service providing module 230. The request for consignment may be provided by the publisher.

Moreover, the advertisement application service providing module 220 updates advertisement resource information associated with the corresponding publisher in the database 280 based on the content of the newly executed operation (S16).

At this time, information retrieved from the database 280 and information provided to the screen by the advertisement application service providing module 220 may be is information associated with an advertisement resource, of which both ownership and management authority may belong to the corresponding publisher.

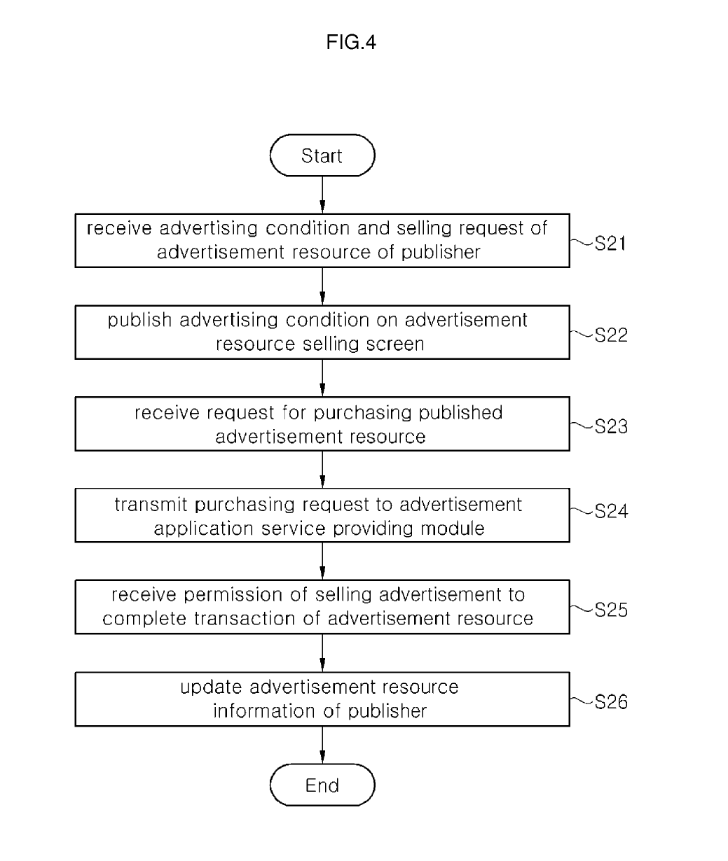

FIG. 4 is a flow diagram illustrating an operation of an opened transaction service providing module according to an exemplary embodiment of the invention.

Referring to FIG. 4, the opened transaction service providing module 230 receives an advertising condition of the advertisement resource belonging to the publisher and a request for selling the advertisement resource from the advertisement application service providing module 220 (S21).

As a result, the opened transaction service providing module 230 publishes the advertising condition of the corresponding advertisement resource onto an advertisement resource selling screen, which can be read by the advertiser or advertisement agency (S22).

The opened transaction service providing module 230 receives a request for purchasing the published advertisement resource from a reference advertiser or advertisement agency (S23).

The opened transaction service providing module 230 transmits the purchasing request from the advertiser or advertisement agency to the advertisement application service providing module 220 (S24). The purchasing request transmitted to the advertisement application service providing module 220 may be displayed on the screen provided to the publisher by the advertisement application service providing module 220.

The opened transaction service providing module 230 receives a publisher's permission of selling the advertisement from the advertisement application service providing module 220 to complete the transaction of the corresponding advertisement resource (S25).

The advertisement application service providing module 220 updates is advertisement resource information associated with the corresponding publisher in the database 280 based on the completion selling of the advertisement resource (S26).

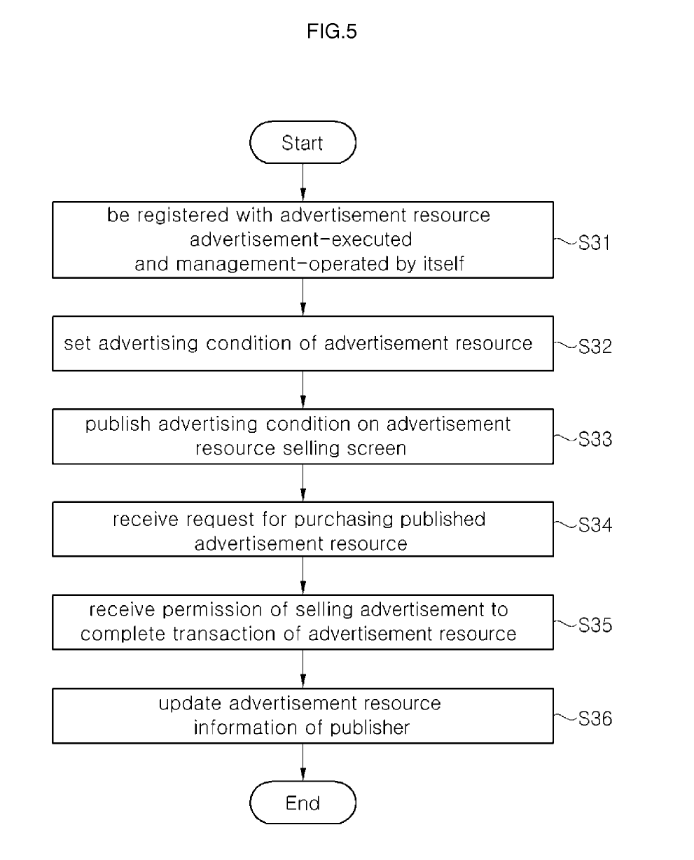

FIG. 5 is a flow diagram illustrating an operation of an opened transaction service providing module according to an exemplary embodiment of the invention.

Referring to FIG. 5, the opened transaction service providing module 230 may be registered with advertisement resources, which may be executed and/or managed by the service providing module 230 if the corresponding advertisement resources are not the advertisement resources of the publishers (S31).

The opened transaction service providing module 230 sets the advertising condition of the corresponding advertisement resource based on a reference advertising condition (S32).

The opened transaction service providing module 230 publishes the advertising condition of the advertisement resources, which may be executed and/or managed by the opened transaction service providing module 230, on the advertisement resource selling screen, which can be read by the advertiser or advertisement agency if the corresponding advertisement resources are not the advertisement resources of the publishers (S33).

The opened transaction service providing module 230 receives a request for purchasing the published advertisement resource from a reference advertiser or advertisement agency (S34).

The opened transaction service providing module 230 permits a purchasing request for the advertisement resources from the advertiser or advertisement agency to be completed (S35).

Moreover, the advertisement application service providing module 220 updates is advertisement resource information associated with the corresponding publisher in the database 280 based on the completion of the purchase transaction (S36).

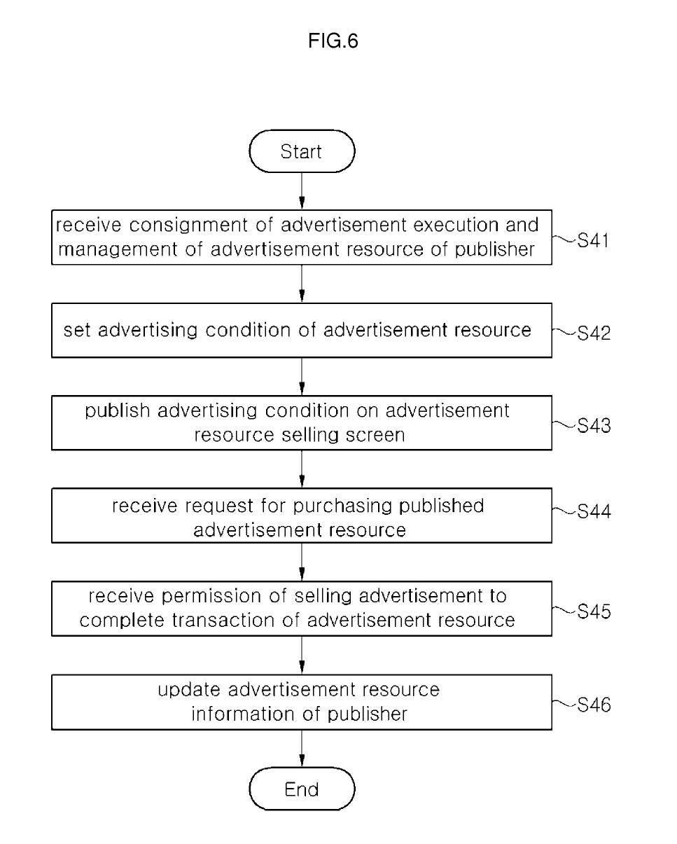

FIG. 6 is a flow diagram illustrating an operation of an opened transaction service providing module according to an exemplary embodiment of the invention.

Referring to FIG. 6, the opened transaction service providing module 230 receives a consignment of advertisement execution and/or management operation of the advertisement resources of the publishers from the advertisement application service providing module 220 (S41).

The opened transaction service providing module 230 sets an advertising condition of the consigned advertisement resources (S42). Herein, the advertising condition may be a selling condition.

The opened transaction service providing module 230 publishes the advertising condition of the corresponding advertisement resource onto the advertisement resource selling screen which can be read by the advertiser or advertisement agency (S43).

The opened transaction service providing module 230 receives a request for purchasing the published advertisement resource from a reference advertiser or advertisement agency (S44).

The opened transaction service providing module 230 permits a purchasing request from the advertiser or advertisement agency to complete the transaction of the corresponding advertisement resource (S45).

The opened transaction service providing module 230 transmits a traction completion result to the advertisement application service providing module 220 (S46). The transaction completion result transmitted to the advertisement application service providing is module 220 may be displayed on the screen provided to the publisher by the advertisement application service providing module 220.

As apparent from the above description, according to exemplary embodiments of the present invention, the access of use-registered publishers and the user of an advertisement application service are permitted through an advertisement application service providing module to allow the corresponding publishers to sell and manage their own advertisement resources.

The exemplary embodiments of the present invention include a computer readable medium including program commands for performing operations implemented by various computers. The computer readable medium may include program instructions, local data files, local data structure, or the like, alone or a combination thereof. The computer readable medium may be designed and constituted especially for the present invention, or may be known to those skilled in a computer software field. Examples of the computer readable medium may include a magnetic medium such as a hard disk, a floppy disk, and a magnetic tape; an optical recording medium such as a CD-ROM, a DVD; a magneto-optical medium such as a floptical disk; and a hardware device specially configured to store and perform program commands such as a ROM, a RAM, a flash memory, or the like. The computer readable medium may also be a transmission medium such as light including carriers transmitting a signal specifying program commands, data structures, or the like, a metal line, a waveguide, or the like.

Examples of the program commands may include machine language codes such as being made by compilers as well as high-level language codes capable of being executed by computers using interpreters or the like.

Although the banner advertisement has been described in various exemplary embodiments of the present invention, the present invention is not limited thereto but may is include various forms of online advertisements, for example, a search advertisement, a contextual advertisement, and the like, that may be available on cyber space.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

1. An advertisement service system, comprising:
an advertisement application service providing module to provide an advertisement application service to a publisher, wherein the advertisement application service provides the publisher online access to manage operation of an advertisement resource belonging to the publisher;
an opened transaction service providing module to provide an opened transaction service that enables advertisement resource of the publisher to be transacted between the publisher and an advertiser or an advertisement agency; and
an advertisement reporting module to provide a report about the advertisement resource executed by the advertisement application service providing module.

2. The advertisement service system of claim 1, wherein the opened transaction service providing module transacts the advertisement resource with respect to the advertiser or the advertisement agency, and wherein the advertisement resource is managed by the advertisement application service providing module.

3. The advertisement service method of claim 2, wherein the opened transaction service providing module further allows the advertisement resource to be transacted with respect to the advertiser or the advertisement agency using an auction scheme, and wherein the advertiser or the advertisement agency obtains consignment of the advertisement resource from the publisher based on an amount bidded by the advertiser or the advertisement agency.

4. The advertisement service system of claim 1, wherein the opened transaction service providing module transacts the advertisement resource with respect to the advertiser or the advertisement agency, and wherein the advertisement resource is consigned from the publisher to the advertiser or the advertisement agency.

5. The advertisement service system of claim 1, further comprising a charge processing module to estimate a charge related to the advertisement application service providing module according to a traffic volume generated.

6. The advertisement service system of claim 1, wherein the advertisement application service providing module enables the advertisement resource to be applied to an advertisement, and wherein the advertisement resource is a free advertisement resource or a paid advertisement resource.

7. The advertisement service system of claim 6, further comprising a charge processing module to permit the publisher to use the advertisement application service providing module for free in response to an execution rate of the paid advertisement resources being equal to or more than a reference rate.

8. The advertisement service system of claim 6, further comprising a charge processing module to estimate a reference rate of revenues by execution of the paid advertisement resources as the charge for the advertisement application module.

9. An advertisement service method, comprising:
providing an advertisement application service by online access of a registered publisher for management operation of its own advertisement resource by an advertisement application service providing module;
providing an opened transaction service for enabling the advertisement resource of the publisher to be transacted between the publisher and an advertiser or an advertisement agency; and
providing a report about the advertisement resources executed by the advertisement application service providing module to the publisher and the advertiser or the advertisement agency.

10. The advertisement service method of claim 9, wherein providing of the opened transaction service comprises allowing the advertisement resource to be transacted with respect to the advertiser or the advertisement agency, and wherein the advertisement resource is managed by the advertisement application service providing module.

11. The advertisement service method of claim 10, wherein providing of the opened transaction service further comprises allowing the advertisement resource to be transacted with respect to the advertiser or the advertisement agency using an auction scheme, and wherein the advertiser or the advertisement agency obtains consignment of the advertisement resource from the publisher based on an amount bidded by the advertiser or the advertisement agency.

12. The advertisement service method of claim 9, wherein the providing of the opened transaction service comprises allowing the advertisement resource to be transacting with the advertiser or the advertisement agency, and wherein the advertisement resource is consigned from the publisher to the advertiser or the advertisement agency.

13. The advertisement service method of claim 9, further comprising estimating a charge for the advertisement application service providing module according to a traffic volume generated.

14. The advertisement service method of claim 9, wherein the providing of the advertisement application service comprises the advertisement application service providing module applying the advertisement resource to the advertisement, and wherein the advertisement resource is a free advertisement resource or a paid advertisement resource.

15. The advertisement service method of claim 14, further comprising allowing the publisher to use the advertisement application service providing module for free in response to an execution rate of the paid advertisement resources being equal to or more than a reference rate.

16. The advertisement service method of claim 14, further comprising estimating a reference rate of revenues by execution of the paid advertisement resources as the charge for the advertisement application module.

17. A computer-readable recording medium storing a computer program executed through at least one computer component and comprising a program command to perform an advertisement service of an advertisement service system using a communication network, wherein:
the computer-readable recording medium enables, by the execution, an advertisement service method comprising,
providing an advertisement application service for online access of a registered publisher for allowing management operation of its own advertisement resource by an advertisement application service providing module;
providing an opened transaction service for enabling the advertisement resource of the publisher to be transacted between the publisher and an advertiser or an advertisement agency; and
providing a report about the advertisement resources executed by the advertisement application service providing module to the publisher and the advertiser or the advertisement agency.

18. The computer-readable recording medium of claim 17, wherein providing of the opened transaction service comprises allowing the advertisement resource to be transacted with respect to the advertiser or the advertisement agency, and wherein the advertisement resource is managed by the advertisement application service providing module.

19. The computer-readable recording medium of claim 17, wherein the providing of the opened transaction service comprises allowing the advertisement resource to be transacting with the advertiser or the advertisement agency, and wherein the advertisement resource is consigned from the publisher to the advertiser or the advertisement agency.

20. The computer-readable recording medium of claim 17, wherein by the execution, the computer-readable recording medium further estimates a charge for the advertisement application service providing module according to a traffic volume generated.

21. The computer-readable recording medium of claim 17, wherein the providing of the advertisement application service comprises the advertisement application service providing module applying the advertisement resource to the advertisement, and wherein the advertisement resource is a free advertisement resource or a paid advertisement resource.

22. The computer-readable recording medium of claim 21, wherein the computer-readable recording medium further performs charge processing for the publisher to use the advertisement application service providing module for free in response to an execution rate of the paid advertisement resources being equal to or more than a reference rate.
